(19) United States
(12) Patent Application Publication
(10) Pub. No.: US 2026/0229566 A1
(43) Pub. Date: Aug. 6, 2026

(54) METHOD FOR CONTROLLING A FUEL CELL SYSTEM

(71) Applicant: Robert Bosch GmbH, Stuttgart (DE)

(72) Inventors: Helerson Kemmer, Vaihingen (DE); Leonie Sophie Moeller, Stuttgart (DE); Manlin Zhan, Boeblingen (DE); Mark Hellmann, Korntal (DE); Matthias Rink, Herrenberg (DE)

(21) Appl. No.: 19/154,008

(22) PCT Filed: Jan. 23, 2024
(86) PCT No.: PCT/EP2024/051526

§ 371 Date: Aug. 6, 2025

(30) Foreign Application Priority Data
Feb. 7, 2023 (DE) 10 2023 200 957.9
Nov. 15, 2023 (DE) 10 2023 211 365.1

(51) Int. Cl. H01M 8/04746; H01M 8/0444; H01M 8/04492; H01M 8/04828

(52) U.S. Cl. CPC H01M 8/04761; H01M 8/04462; H01M 8/04514; H01M 8/04843

(57) ABSTRACT

A method for controlling a fuel cell system (100) is proposed. The fuel cell system (100) comprises a fuel cell stack (10) with an anode side (11) and a cathode side (12), an exhaust gas line (13), a fuel line with a recirculation circuit (14), and at least one valve line (15) connected to the recirculation circuit (14). The at least one valve line (15) and the exhaust gas line (13) merge into a measurement line (16). The at least one valve line (15) has a valve (18). The method comprises the following steps:
(S1) measuring an H₂ concentration and/or an H₂O concentration in the measurement line (16),
(S2) determining the H2 concentration, N2 concentration, the vapor concentration and/or the water amount on the anode side (11) of the fuel cell stack (10) on the basis of the measured H₂ concentration and/or the measured H₂O concentration, by means of a trained machine-learning method (20), and
(S3) adapting a purge duration and/or a purge interval on the basis of the determined H₂ concentration and/or N₂ concentration on the anode side (11) of the fuel cell stack (10) and adapting a drain duration and/or a drain interval on the basis of the determined vapor concentration and/or the water amount on the anode side (11) of the fuel cell stack (10), or
(S4) adapting a drain duration and/or a drain interval on the basis of the determined vapor concentration and/or the water amount on the anode side (11) of the fuel cell stack.

### BACKGROUND

The invention relates generally to the field of fuel cells, in particular to the PEM fuel cells. More specifically, the invention relates to a method for controlling a fuel cell system, a method for training a machine-learning method for a method for controlling a fuel cell system, and a fuel cell system.

In polymer electrolyte membrane fuel cells (PEM fuel cells) powered by hydrogen and air, a proton-conducting membrane separates the gases of two galvanic half-cells from one another. The anode side is filled with hydrogen and the cathode side with air. Due to differences in concentration and a non-completely gas-tight membrane, gasses are nonetheless transferred.

In particular, the accumulation of nitrogen on the anode side ensures that the hydrogen concentration there decreases. In addition to reduced voltage and thus reduced efficiency, this also results in the risk of hydrogen depletion, which can lead to irreversible damage.

The nitrogen concentration on the anode side is kept low according to prior art by regularly draining a portion of the anode gas via a valve and replacing it with pure hydrogen. Such a process is called a “purge”. The valve opening duration and valve closing duration are based on empirical values and are typically stored in the purge strategy of the system as a function of the flow.

Furthermore, liquid water must be periodically removed from the anode side. The removal of liquid water may be referred to as a “drain” process. If draining is performed too rarely, this can lead to hydrogen depletion. Conversely, draining too often can lead to hydrogen wastage. Excessive purging or draining can reduce the vapor concentration on the anode side below a critical concentration, which can dry out the fuel cells.

With heuristical control of the purge processes and/or drain processes, it can neither be ensured that a sufficient distance is maintained from the depletion limit nor can the purge strategy or drain strategy be optimized with respect to hydrogen consumption.

### SUMMARY

The method according to the invention for controlling a fuel cell system with the features of the independent claim has the advantage that a purge strategy and a drain strategy, or a drain strategy, is/are precisely, accurately and reliably improved with the help of an H₂ sensor this is already existent for safety reasons.

The proposed method is more cost effective, reliable and precise than prior art methods. The proposed method also enables a fuel cell system to be provided that has a longer service life than prior art fuel cell systems.

Features and details described in connection with the method according to the invention for controlling a fuel cell system clearly also apply in connection with the method for training a machine-learning method according to the invention, the fuel cell system, the computer program product and/or the computer-readable medium, and respectively vice versa so that, with respect to the disclosure, mutual reference to the individual aspects of the invention is or can always be made.

A first aspect of the present disclosure relates to a method of controlling a fuel cell system, particularly a PEM fuel cell system. The fuel cell system comprises a fuel cell stack with an anode side and a cathode side, an exhaust gas line, a fuel line with a recirculation circuit, and at least one valve line connected to the recirculation circuit. The at least one valve line and the exhaust gas line merge into a measurement line. The at least one valve line has a valve. The method comprises the following steps:
measuring an H₂ concentration and/or an H₂O concentration in the measurement line,
determining the H₂ concentration, N₂ concentration, the vapor concentration and/or the water amount on the anode side of the fuel cell stack on the basis of the measured H₂ concentration and/or the measured H₂O concentration, by means of a trained machine-learning method, and
adapting a purge duration and/or a purge interval on the basis of the determined H₂ concentration and/or N₂ concentration on the anode side of the fuel cell stack and adapting a drain duration and/or a drain interval on the basis of the determined vapor concentration and/or the water amount on the anode side of the fuel cell stack, or
adapting a drain duration and/or a drain interval on the basis of the determined vapor concentration and/or the water amount on the anode side of the fuel cell stack.

In other words, a purge strategy and drain strategy, or a drain strategy, may be defined, optimized, and/or adapted, in which a purge duration and/or a purge interval and a drain duration and/or a drain interval, or an optimized purge duration or drain duration, or an optimized purge interval or drain interval can be determined. The purge strategy may define the “how”, the “whether”, the “how often”, the “how long” and/or the “when” of a purge process.

The drain strategy may define the “how”, the “whether”, the “how often”, the “how long” and/or the “when” of a drain process.

Furthermore, in other words, a method may be provided that enables measurement data of an already existing sensor of a fuel cell system to be used along with a trained machine-learning method to provide an accurate estimate of hydrogen concentration on the anode side of the fuel cell system. Accordingly, a virtual measurement of hydrogen concentration, nitrogen concentration, vapor concentration and/or water amount may be performed on the anode side using the trained machine-learning method. The trained machine-learning method may be an AI model.

The measurement of the H₂ concentration and/or an H₂O concentration in the measurement line may be performed using an H₂ sensor. In particular, the measurement of the H₂ concentration and/or an H₂O concentration in the measurement line may be performed by means of an already existing sensor, because in each fuel cell system, an H₂ sensor is arranged in the exhaust line as a standard to measure or monitor the H₂ concentration for safety reasons. Such an H₂ sensor may also be configured to sense a vapor concentration in the measurement line. It is also conceivable to provide a sensor on the measurement line that is configured to detect a vapor concentration and/or a water amount.

Accordingly, two signals, an H₂ concentration signal and an H₂O concentration signal may be generated from the measurement of the H₂ concentration and/or the H₂O concentration and fed to the trained machine-learning method. That is to say that, by measuring the H₂ concentration and/or the H₂O concentration, the input signals or the input signal for the trained machine-learning method can be generated. In addition, a measurement of the vapor concentration may be performed. From such a measurement, a corresponding signal, a vapor concentration signal, may be generated and provided to the trained machine-learning method. However, such a vapor concentration signal is only optional.

The trained machine-learning method may determine the H₂ concentration, the N₂ concentration, the vapor concentration, and/or the water amount on the anode side of the fuel cell stack. The term determining is to be broadly understood in the context of the present disclosure. Determining the H₂ concentration, the N₂ concentration, the vapor concentration and/or the water amount on the anode side may be a very accurate and precise estimate of the H₂ concentration, the N₂ concentration, the vapor concentration and/or the water amount on the anode side. Accordingly, the trained machine-learning method may output a signal including information regarding H₂ concentration, N₂ concentration, vapor concentration, and/or water amount. For example, on the basis of such a signal, a control unit of a fuel cell system may optimize a purge strategy and drain strategy, or a drain strategy, by adjusting or determining a purge duration, a drain duration, and/or a purge interval, or a drain interval.

In the context of the present disclosure, the term “on the basis of” is broad. This may be understood to mean a correlation, a dependency, and/or a relationship with each other.

With such a method, a virtual mass spectrometer is essentially provided, because by means of the trained machine-learning method, data can be determined that a mass spectrometer arranged on the recirculation circuit would or could provide. With such a method, a virtual water quantity meter is essentially provided, because by means of the trained machine-learning method, data can be determined that a water quantity meter arranged on the recirculation circuit would or could provide.

Such a method therefore allows for determining a feedback-controlled purge strategy and drain strategy, or drain strategy. As a result, the fuel cell system can be protected from hydrogen depletion so that such a fuel cell system can enjoy a longer life. In addition, waste of hydrogen may be reduced by unnecessary purges and/or drain procedures.

It is advantageous if the valve of the at least one valve line is a purge and drain valve. In other words, a single valve may be provided on the valve line, which is configured to perform both a purge procedure and a drain procedure.

It is advantageous for the fuel cell system to have two valve lines, wherein a first valve line comprises a purge valve, and a second valve line comprises a drain valve.

Accordingly, the first valve line may be referred to as a purge line and the second valve line may be referred to as a drain line.

It is advantageous if the trained machine-learning method is a Gauss process model, particularly with NARX structure.

It is advantageous to train the trained machine-learning method using a training fuel cell system. The training fuel cell system comprises a fuel cell stack with an anode side and a cathode side, an exhaust gas line, a fuel line with a recirculation circuit, at least one valve line connected to the recirculation circuit, a mass spectrometer, and a water quantity meter. The mass spectrometer is configured to sense the H₂ concentration and/or N₂ concentration on the anode side of the training fuel cell system. The water quantity meter is configured to sense a water amount on the anode side of the training fuel cell system.

In other words, a training fuel cell system may be provided, which may be used to train the trained machine-learning method. The training fuel cell system may essentially differ from the fuel cell system in that it now also has a mass spectrometer on the recirculation circuit. The training fuel cell system may further comprise a water quantity meter in the recirculation circuit adapted to record the water amount and, in particular, the vapor concentration. The training fuel cell system may comprise a drain line through which a water amount may be sensed (only on the test bench). Such a drain line may be connected in parallel to the valve line.

As a result, a reliable trained machine-learning method may be provided which may be used to determine the H₂ concentration, the N₂ concentration, the vapor concentration and/or the water amount on the anode side. This, in turn, can reliably and precisely determine the H₂ concentration, the N₂ concentration, the vapor concentration and/or the water quantity. This allows for improved control of the fuel cell system. This further enables the provision of an accurate and reliable purge strategy and drain strategy, or drain strategy.

Better control of the fuel cell system may result in a more accurate and better purge strategy and/or drain strategy. Again, this may result in the respective fuel cell system enjoying a longer life. Consequently, the purge strategy and/or drain strategy can be optimized, resulting in less hydrogen being wasted while operating a corresponding fuel cell system.

It is advantageous if the method further comprises the steps of:
deriving at least one characteristic of the corresponding measurement from the measured H₂ concentration and/or from the measured H₂O concentration, and
determining the H₂ concentration, N₂ concentration, the vapor concentration and/or the water amount on the anode side of the fuel cell stack on the basis of the at least one derived characteristic of the corresponding measurement, by means of the trained machine-learning method.

In other words, a characteristic of the measured H₂ concentration and/or a characteristic of the measured H₂O concentration may be used as an input signal or input data for the trained machine-learning method. Features or characteristics of the measured H₂ concentration and/or the measured H₂O concentration may be extracted, i.e., the measured H₂ concentration and/or the measured H₂O concentration may be pre-processed to derive a characteristic or several characteristics therefrom.

That is, the trained machine-learning method may determine H₂ concentration, N₂ concentration, vapor concentration, and/or water amount on the anode side of the fuel cell stack on the basis of a pre-processed measurement of the H₂ concentration and/or H₂O concentration.

Examples of a characteristic are a peak height, the area below the peak, and the trend of the peak slope.

Thus, the H₂ concentration, the N₂ concentration, the vapor concentration and/or the water amount on the anode side can be determined more reliably and precisely. This, in turn, enables a more accurate and better optimization of the purge strategy and drain strategy.

It is advantageous if the method further comprises the following step:
deriving at least one parameter of a purge strategy and/or drain strategy performed from the determined H₂ concentration, the determined N₂ concentration, the determined vapor concentration and/or the determined water amount on the anode side of the fuel cell stack.

In other words, the output signal(s) of the trained machine-learning method may be reworked. Parameters of a purge strategy and a drain strategy or a purge process or a drain process that have been carried out can be extracted from the output signal(s) of the trained machine-learning method.

It is advantageous if the method is applied at predetermined time intervals for different power levels or operating parameters.

It is advantageous if the step of determining the H₂ concentration, N₂ concentration, the vapor concentration and/or the water amount on the anode side of the fuel cell stack is on the basis of further system data, in particular on further measured system data, using the trained machine-learning method.

In other words, the machine-learning method may be configured to provide additional input or accept input signals. The input signals of the machine-learning method can also be used to obtain additional system data or signals. For example, further sensors may be provided that can measure further system data and can be transmitted to the machine-learning method. For example, a mass air flow sensor may be provided.

A second aspect of the present disclosure relates to a method of training a machine-learning method for a method for controlling a fuel cell system, as described above and below,
comprising the following steps:
generating a training data set using a mass spectrometer, a water quantity meter, and an H₂ sensor and/or H₂O sensor of a training fuel cell system,
creating an input dataset by normalizing and reworking the training dataset, and
training the machine-learning method with the input data set, which is in particular a dynamic Gauss process model.

Although the sensor used is referred to as an H₂ sensor, it may be a sensor capable of sensing and/or measuring both a concentration of H₂ and a concentration of H₂O. The step of generating a training dataset may consist of carrying out one or more measurements using the H₂ sensor, the water quantity meter, and the mass spectrometer. One or more measurements may be used as a knowledge base for training the machine-learning method. The water quantity meter may sense a water amount, i.e., an amount of liquid water, and optionally additionally a vapor concentration.

The training data set can be activated by additional relevant data, e.g. mass flow at an air inlet, stack flow, or anode outlet pressure, as well as characteristics or modifications extracted from this data.

The generated training data set or data can then be edited to meet machine-learning method requirements. In other words, the generated training dataset may be edited or processed so that the machine-learning method may accept the edited or processed training dataset as the input dataset. Any such editing or processing may include normalization and reworking.

The normalization may be on the basis of the average value and/or the variance of the training data set.

It is advantageous if the method further comprises the following step:
validating the trained machine-learning method using a subset of the input dataset.

It is advantageous if the method of training the machine-learning method further comprises the steps of:
testing the trained machine-learning method for final validation of the machine-learning method with a validation data set generated by the H₂ sensor, the water quantity meter, and the mass spectrometer, and
determining H₂ concentration, N₂ concentration, the vapor concentration, and/or the water amount on the anode side of the fuel cell stack of the training fuel cell system on the basis of the validation data set, using the tested trained machine-learning method,
wherein the determined H₂ concentration, N₂ concentration, vapor concentration and/or water amount on the anode side of the fuel cell stack of the training fuel cell system is compared to H₂ concentration data and/or N₂ concentration data measured by the mass spectrometer on the anode side of the fuel cell stack. Additionally, the determined vapor concentration and/or the water amount on the anode side of the fuel cell stack of the training fuel cell system may be compared to the vapor concentration and/or the water amount measured by the water quantity meter on the anode side of the fuel cell stack.

Although the sensor used is referred to as an H₂ sensor, it may be a sensor capable of sensing and/or measuring both a concentration of H₂ and a concentration of H₂O.

With such a method for training the machine-learning method, the accuracy and reliability, with which the H₂ concentration, the N₂ concentration, the vapor concentration, and the water quantity on the anode side can be determined, can be advantageously increased.

Accordingly, improved control of the fuel cell system as well as more accurate and better optimization of the purge strategy and/or drain strategy may be realized.

In the context of the present disclosure, the term data set, e.g. in validation data set, in input data set, or in training data set, refers to a quantity of data pairs or groups of data comprising the related input and output values of a method, in particular the machine-learning method. For example, the validation data set may include values of the H₂ and/or H₂O signal, or an H₂ concentration and/or an H₂O concentration from the measurement line, as well as associated values of the mass spectrometer (H₂ concentration and/or N₂ concentration). Additionally, the validation data set may include values of the water quantity meter.

All advantages described in detail regarding the method for optimizing a purge strategy of a fuel cell system according to the first aspect of the invention shall also apply to the method for training a machine-learning method for a method for controlling a fuel cell system according to the second aspect of the invention.

A third aspect of the present disclosure relates to a fuel cell system, more particularly a PEM fuel cell system. The fuel cell system comprises a fuel cell stack with an anode side and a cathode side, an exhaust gas line, a fuel line with a recirculation circuit, and at least one valve line connected to the recirculation circuit. The at least one valve line and the exhaust gas line merge into a measurement line. the fuel cell system also comprises an H₂ sensor and/or H₂O sensor located on the measurement line and a control unit. The control unit is configured to carry out steps of the method as described above and below. The fuel cell system may further comprise a valve, which may be configured as a purge and drain valve. Alternatively, the fuel cell system may comprise two valves, wherein one valve is a purge valve and a second valve is a drain valve. The fuel cell system may further comprise a water separator. In this case, a drain valve is preferably upstream of a water separator.

The advantages discussed in relation to the method for controlling a fuel cell system apply equally to the fuel cell system according to the present invention. Accordingly, such a fuel cell system may be durable and costs may be efficiently reduced.

The fuel cell system according to the third aspect of the invention also has the same advantages as have already been described for the first and second aspects of the invention.

A fourth aspect of the present disclosure relates to a computer program product comprising instructions that, when executed by a control unit, prompt the control unit to perform a method for controlling a fuel cell system, as described above and below.

A fifth and last aspect of the present disclosure relates to a computer readable medium having stored thereon the computer program product as described above.

The advantages described in detail regarding the methods according to the first and second aspects of the invention also apply correspondingly to the computer program product according to the fourth aspect of the invention as well as the computer readable medium according to the fifth aspect of the invention.

All disclosures described above and below with respect to one aspect of the present disclosure apply equally to all other aspects of the present disclosure.

### BRIEF DESCRIPTION OF THE DRAWINGS

In the following, exemplary embodiments of the invention are described with reference to the figures.

FIG. 1 schematically shows a fuel cell system in accordance with an exemplary embodiment,

FIG. 2 shows a schematic flow diagram of a method in accordance with an exemplary embodiment,

FIG. 3 shows a flow diagram of a method in accordance with an exemplary embodiment,

FIG. 4 schematically shows a fuel cell system in accordance with an exemplary embodiment, and

FIG. 5 schematically shows a measurement of a purge operation.

### DETAILED DESCRIPTION

Similar, similarly acting, identical or identically acting elements are provided with similar or the same reference numbers in the figures. The figures are merely schematic and are not to scale.

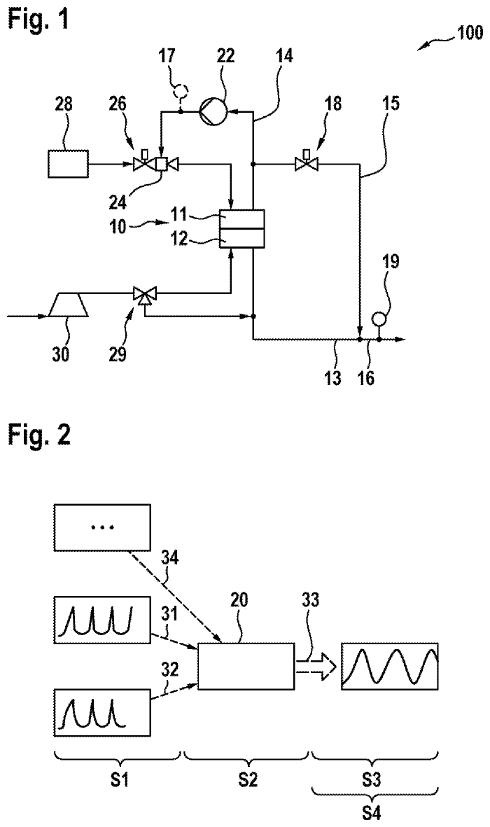

FIG. 1 schematically illustrates a fuel cell system 100 in accordance with an exemplary embodiment. The fuel cell system 100 comprises at least one fuel cell stack 10 having an anode side 11 and a cathode side 12. The fuel cell system 100 also has an air path, through which air can be supplied from the environment of the cathode side 12. An air compressor and/or a three-way valve 29, which compresses and/or draws in the air in accordance with the respective operating conditions of the fuel cell stack 10, is arranged in the air path. The three-way valve 29 allows air to pass by the stack when it is not needed. A compressor 30 may also be installed in front of the three-way valve 29. Further components, e.g., a filter and/or a heat exchanger and/or valves, can be provided in the air path. Air containing oxygen is made available to the fuel cell stack 10 via the air path.

The fuel cell system 100 further includes an exhaust gas line 13, a fuel line with a recirculation circuit 14, and a valve line 15 connected to the recirculation circuit 14. The valve line 15 and exhaust line 13 merge into a measurement line 16.

A high pressure tank 28 and a shut-off valve 26 are located in the inflow of the fuel line. Further components may be located in the fuel line, such as a jet pump 24 or a blower 22, to provide fuel to the anode side 11 of the fuel cell system 100.

The valve line 15 comprises a valve 18. The valve 18 may be configured as a purge and drain valve. The valve line 15 is arranged between the recirculation circuit 14 and the exhaust gas line 13 so that the gas mixture can flow from the recirculation circuit 14 into the measurement line 16. An H₂ sensor 19 is arranged on the measurement line 16, which is configured to detect an H₂ concentration and/or an H₂O concentration in the measurement line 16. Furthermore, a water quantity meter may be located on the measurement line 16 (not shown here). The water quantity meter may sense a water amount (i.e., an amount of liquid water), and/or a vapor concentration. It is noted that the H₂ sensor and the water quantity sensor may be configured as a single combination sensor.

FIG. 1 shows a fuel cell system 100 that does not have a mass spectrometer 17. A training fuel cell system 100 could have essentially the same components or elements as the fuel cell system 100 of FIG. 1. The training fuel cell system 100, in contrast to the fuel cell system 100 of FIG. 1, further comprises a mass spectrometer 17 and a water quantity meter (not shown here) located in the recirculation circuit 14. The fuel cell system 100, which is not the training fuel cell system 100, preferably has neither a mass spectrometer 17 nor a water quantity meter in the recirculation circuit.

The components and/or elements of the fuel cell system 100 of FIG. 1 may be controlled via a control unit (not shown here). In particular, valve 18 which serves as a purge valve and as a drain valve may be controlled via such a control unit.

FIG. 2 shows a schematic flow diagram of a method for controlling a fuel cell system 100, particularly a fuel cell system 100 as shown in FIG. 1, in accordance with an exemplary embodiment. The method may be combined into three method steps, wherein the third method step may be either S3 or S4.

In a first step S1, measurement data is acquired. In particular, an H₂ concentration and/or an H₂O concentration is measured on the measurement line 16. Corresponding data may be generated on the basis of such a measurement. In FIG. 2, the dashed arrow 31 represents the transmission of a measured H₂ concentration to the trained machine-learning method 20, which is symbolically represented by a box. In FIG. 2, the dashed arrow 32 depicts the transmission of a measured H₂O concentration to trained machine-learning method 20, which is symbolically represented by a box. Such transmission may be by means of signals. In FIG. 2, the dashed arrow 34 provides an optional transmission of further system data, or a system signal, such as mass air flow, to the trained machine-learning method 20. Additional inputs or input signals can be transmitted to the trained machine-learning method 20. The number of signals that the trained machine-learning method 20 can accept as input is not limited.

In a further step S2, the trained machine-learning method 20 determines the H₂ concentration, the N₂ concentration, the vapor concentration and/or the water amount on the anode side 11 of the fuel cell stack 10, wherein the trained machine-learning method 20 is based on the H₂ concentration and/or the H₂O concentration measured in the measurement line 16. In other words, the trained machine-learning method 20 accepts the measured H₂ concentration and/or the H₂O concentration as input signals 31, 32 and can provide the H₂ concentration, N₂ concentration, the vapor concentration, and/or the water amount on the anode side 11 as an output signal 33 or output.

In a third step S3, on the basis of the determined H₂ concentration and/or N₂ concentration, a purge duration and/or a purge interval and a drainage duration and/or a drainage interval is adapted or determined. In other words, in a third step S3, a purge strategy as well as a drain strategy is determined and, if necessary, optimized by determining an optimal purge duration and/or an optimal purge interval and an optimal drain duration and/or an optimal drain interval for the valve 18.

As an alternative to step S3, in a third step S4 only a drain duration and/or a drain interval can be determined.

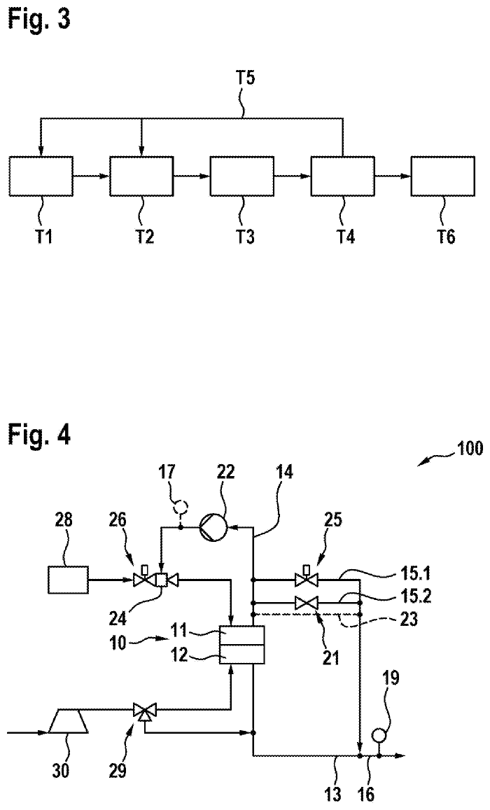

FIG. 3 shows a flow chart of a method for training the machine-learning method 20, according to an exemplary embodiment. In a first step, T1, a training data set is generated using a mass spectrometer 17, a water quantity meter, and an H₂ sensor 19 of a training fuel cell system 100. In other words, a measurement is performed as the basis for a training data set. Such a training dataset may be suitable for an input dataset. A training data set may include measurement data from the H₂ sensor 19, which may be provided with labels from the mass spectrometer 17 and from the water quantity meter. In order for this knowledge base to include as extensive a system behavior as possible, it may prove particularly advantageous to consider at least one of the following points when measuring with the H₂ sensor 19:

During a measurement, the mass spectrometer 17 and the water quantity meter should always remain on, because the mass spectrometer 17 and the water quantity meter provide a label, i.e., a target value for the output of the machine-learning method 20, for each measured H₂ concentration and/or H₂O concentration.
A measurement of the H₂ sensor 19 is intended to cover as large a relevant load range as possible so that the machine-learning method 20 trained therefrom can have a wide range of validity.

The H₂ sensor 19 is to indicate a peak during each purge procedure and/or drain procedure. Display of zero values over a plurality of purges and/or drain procedures should be avoided. This may occur in particular at high current levels because a high mass air flow is passed through the cathode, which dilutes the hydrogen mass flow in the exhaust gas.
A measurement of the H₂ sensor 19 is intended to include various system dynamics. For this purpose, a transient measurement may be performed at different current levels. A current signal with step changes between 50, 100, 120 and/or 237 A, for example, can be run. Each time the current level is changed, a transient path may result in the mass spectrometer 17 and/or the water quantity meter. By subsequently holding the current level for a certain time, both dynamic and static system behaviors can be incorporated into the training data.

Thus, the trained machine-learning method 20 can determine the H₂ concentration, the N₂ concentration, the vapor concentration and/or the water quantity even more precisely and reliably. The measurement to generate a training dataset may only be performed once if no new operational strategy is implemented and if the aging state of the fuel cell stack does not change greatly. Such changes may require the measurement to be repeated for a re-trained machine-learning method 20. Such a repetition can occur, for example, in the workshop as a precautionary measure during regular servicing or with an error message, for example of the H₂ sensor 19.

In a further step T2, the training dataset is normalized and reworked to create an input dataset. In other words, the training dataset is prepared for the machine-learning method 20 to be trained. For this purpose, the training data set may be normalized and outliers may be removed. Filtering of the training dataset may be omitted. However, if necessary, filtering of the training data set may be performed.

In a further step T3, the machine-learning method 20 is trained. The machine-learning method 20 can be trained based in particular on a Gauss process model.

In a next step, T4, the trained machine-learning method 20 is validated. For this purpose, cross-validation may be performed on the basis of the training data set, in particular to avoid overfitting. Thereafter, the trained machine-learning method 20 may be validated on other data sets having different system dynamics. In so doing, the input data of a validation data set should also be normalized, for example, on the basis of the average value and the variance of the training data set.

If large validation errors are present, it may be advantageous to check whether the measurement at the step of generating a training data set T1 satisfies certain requirements and/or whether changes have been made to the operational strategy of the fuel cell system 100. If these cases can be ruled out, the problem may be solved by supplementing the input dataset with one or more characteristic(s). Otherwise, steps T1 and/or T5 may be performed again.

In a further final step T6, the trained machine-learning method 20 can be tested. As a result, a final validation of the trained machine-learning method 20 may be performed. For this purpose, the trained machine-learning method 20 is tested with further measurement data that is independent of the training data and/or validation data. A test data set may therefore be generated by the H₂ sensor 19 and by a water quantity meter that is different from both the training data set and the validation data set.

FIG. 4 schematically illustrates a fuel cell system 100 in accordance with an exemplary embodiment. Unless otherwise described, the fuel cell system of FIG. 4 has the same elements and/or components as the fuel cell system of FIG. 1. Unlike the fuel cell system of FIG. 1, the valve line 15 of the fuel cell system of FIG. 4 is distributed among two lines. A purge line 15.1 and a drain line 15.2 are provided, which are connected in parallel to each other. A purge valve 25 is located on the purge line 15.1 and a drain valve 21 is located on the drain line 15.2. Drain valve 21 is generally connected upstream of a water separator (not shown here). In a training fuel cell system, a mass spectrometer 17 and a water quantity meter may be located in the recirculation circuit 14. In addition, a training fuel cell system may include a training drain line 23. It is conceivable to provide a water quantity meter on the training drain line 23, which can record both the water amount and the vapor concentration in the training drain line.

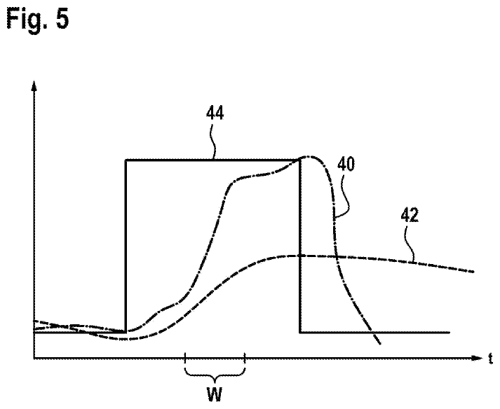

FIG. 5 schematically shows a measurement of a purge operation. On the horizontal axis, time t is shown. The vertical axis is unitless and is merely intended to schematically represent a change in the corresponding variable. The solid line 44 represents the state of a purge valve 25, wherein the displacement in the vertical direction corresponds to an opening of the purge valve 25. The dotted line 40 represents the measured H₂ concentration on the measurement line 16. The dashed line 42 represents the determined H₂ concentration on the anode side 11. In the time period W, the slope of the dotted line is greatest. From a comparatively large slope of the dotted line, i.e., the measured H₂ concentration, the vapor concentration as well as on the nitrogen concentration can be inferred. From a comparatively flat slope, for example, a comparatively high proportion of nitrogen can be inferred.

In addition, it should be noted that terms such as “having”, “comprising”, etc. do not exclude other elements or steps and indefinite articles such as “a” or “an” do not exclude a plurality. Furthermore, it should be noted that features and steps described with reference to any of the above exemplary embodiments may also be used in combination with other features and steps of other exemplary embodiments described above. Reference signs in the claims should not be construed as limitations.

1. A method for controlling a fuel cell system (100), wherein the fuel cell system (100) comprises a fuel cell stack (10) with an anode side (11) and a cathode side (12), an exhaust gas line (13), a fuel line with a recirculation circuit (14) and at least one valve line (15) connected to the recirculation circuit (14), wherein the at least one valve line (15) and the exhaust line (13) merge into a measurement line (16), and the at least one valve line (15) has a valve (18),
comprising
measuring an H₂ concentration and/or an H₂O concentration in the measurement line (16),
determining the H₂ concentration, N₂ concentration, a vapor concentration and/or a water amount on the anode side (11) of the fuel cell stack (10) based on the measured H₂ concentration and/or the measured H₂O concentration, by means of a trained machine-learning method (20), and
adapting a purge duration and/or a purge interval basedon the determined H₂ concentration and/or N₂ concentration on the anode side (11) of the fuel cell stack (10) and adapting a drain duration and/or a drain interval based on determined vapor concentration and/or the water amount on the anode side (11) of the fuel cell stack (10), or
adapting a drain duration and/or a drain interval based on the determined vapor concentration and/or the water amount on the anode side (11) of the fuel cell stack.

2. The method according to claim 1,
wherein
the valve (18) of the at least one valve line (15) is a purge and drain valve.

3. The method according to claim 1,
wherein
the fuel cell system (100) comprises two valve lines (15), wherein a first valve line (15.1) comprises a purge valve and a second valve line (15.2) comprises a drain valve (21).

4. The method according to claim 1,
wherein
the trained machine-learning method (20) is a Gauss process model,

5. The method according to claim
wherein
the trained machine-learning method (20) is trained using a training fuel cell system, wherein the training fuel cell system comprises a fuel cell stack having an anode side and a cathode side, an exhaust gas line, a fuel line with a recirculation circuit, at least one valve line (15) connected to the recirculation circuit, a mass spectrometer (17) and a water quantity meter, wherein the mass spectrometer (17) is configured to record the H₂ concentration and/or N₂ concentration on the anode side of the training fuel cell system and the water quantity meter is configured to record the water amount on the anode side of the training fuel cell system.

6. The method according to claim 1,
wherein
the method further comprises:
deriving at least one characteristic of a corresponding measurement from the measured H₂ concentration and/or from the measured H₂O concentration, and
determining the H₂ concentration, N₂ concentration, the vapor concentration and/or the water amount on the anode side (11) of the fuel cell stack (10) based on the at least one derived characteristic of the corresponding measurement, by means of the trained machine-learning method (20).

7. The method according to claim 1,
wherein
the method further comprising:
deriving at least one parameter of a purge strategy and/or drain strategy performed from the determined H₂ concentration, the determined N₂ concentration of the determined vapor concentration and/or the determined water amount on the anode side (11) of the fuel cell stack (10).

8. The method according to claim 1,
wherein
the method is applied to different power levels or operating parameters at predetermined time intervals.

9. The method according to claim 1,
wherein
determining the H₂ concentration, N₂ concentration, the vapor concentration and/or the water amount on the anode side (11) of the fuel cell stack (10) is based on further measured system data, using the trained machine-learning method (20).

10. A method for training a machine-learning method (20) for a method for controlling a fuel cell system (100) according to claim 1, comprising:
(T1) generating a training data set using a mass spectrometer, a water quantity meter, and an H₂ sensor and/or H₂O sensor (19) of a training fuel cell system,
(T2) creating an input dataset by normalizing and reworking the training dataset, and
(T3) training the machine-learning method with the input data set.

11. The method according to claim 10 further comprising:
(T4) validating the trained machine-learning method using a subset of the input dataset.

12. The method according to claim 10, further comprising:
(T6) testing the trained machine-learning method (20) for final validation of the machine-learning method (20) with a validation data set generated by the H₂ sensor, the water quantity meter, and the mass spectrometer, and
determining H₂ concentration, N₂ concentration, the vapor concentration, and/or the water amount on the anode side of the fuel cell stack of the training fuel cell system based on the validation data set, using the tested trained machine-learning method, wherein the determined H₂ concentration and/or N₂ concentration on the anode side of the fuel cell stack of the training fuel cell system is compared to H₂ concentration data and/or N₂ concentration data measured by the mass spectrometer (17) on the anode side of the fuel cell stack.

13. A fuel cell system (100) comprising:
a fuel cell stack (10) with an anode side (11) and a cathode side (12), an exhaust gas line (13), a fuel line with a recirculation circuit (14) and at least one valve line (15) connected to the recirculation circuit, wherein the at least one valve line (15) and the exhaust line (13) merge into a measurement line (16),
the fuel cell system (100) also comprises an H₂ sensor and/or H₂O sensor (19) located on the measurement line (16) and a control unit,
wherein the control unit is configured to
measure an H₂ concentration and/or an H₂O concentration in the measurement line (16),
determine the H₂ concentration, N₂ concentration, a vapor concentration and/or a water amount on the anode side (11) of the fuel cell stack (10) based on the measured H₂ concentration and/or the measured H₂O concentration, by means of a trained machine-learning method (20), and
adapt a purge duration and/or a purge interval based the determined H₂ concentration and/or N₂ concentration on the anode side (11) of the fuel cell stack (10) and adapt a drain duration and/or a drain interval based on determined vapor concentration and/or the water amount on the anode side (11) of the fuel cell stack (10), or adapt a drain duration and/or a drain interval based on the determined vapor concentration and/or the water amount on the anode side (11) of the fuel cell stack.

14. (canceled)

15. A non-transitory, computer-readable medium containing instructions that when executed by a computer cause the computer to control a fuel cell system (100), wherein the fuel cell system (100) comprises a fuel cell stack (10) with an anode side (11) and a cathode side (12), an exhaust gas line (13), a fuel line with a recirculation circuit (14) and at least one valve line (15) connected to the recirculation circuit (14), wherein the at least one valve line (15) and the exhaust line (13) merge into a measurement line (16), and the at least one valve line (15) has a valve (18), by:
measuring an H₂ concentration and/or an H₂O concentration in the measurement line (16),
determining the H₂ concentration, N₂ concentration, a vapor concentration and/or a water amount on the anode side (11) of the fuel cell stack (10) based on the measured H₂ concentration and/or the measured H₂O concentration, by means of a trained machine-learning method (20), and
adapting a purge duration and/or a purge interval based the determined H₂ concentration and/or N₂ concentration on the anode side (11) of the fuel cell stack (10) and adapting a drain duration and/or a drain interval based on determined vapor concentration and/or the water amount on the anode side (11) of the fuel cell stack (10), or adapting a drain duration and/or a drain interval based on the determined vapor concentration and/or the water amount on the anode side (11) of the fuel cell stack.
